(19) United States
(12) Patent Application Publication
(10) Pub. No.: US 2006/0060100 A1
(43) Pub. Date: Mar. 23, 2006

(54) Method and system for printing a plurality of base materials

(75) Inventors: Regis Thienard, Draveil (FR); Alain Thomas, Saint-Pierre Du Val (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: INOV-MEDIA, a corporation of France, Val de Reuil (FR)

(21) Appl. No.: 11/250,257

(22) Filed: Oct. 14, 2005

Related U.S. Application Data
(63) Continuation of application No. PCT/FR04/00697, filed on Mar. 22, 2004.

(30) Foreign Application Priority Data
Apr. 15, 2003 (FR) 03/04721

(51) Int. Cl. B41F 33/00

(52) U.S. Cl. 101/483

(57) ABSTRACT

A method for printing a plurality of base materials with a device including a plurality of print units, a distribution system for distributing the base materials in the print units and a recovery system for recovering the printed base materials after each of the materials has passed through a print unit, including distributing the base materials in the print units through a top end portion of the print units with the distribution system; and recovering the printed base materials after each of the base materials has passed through a print unit through a bottom end portion of the print units with the recovery system.

### RELATED APPLICATION

This is a continuation of International Application No. PCT/FR2004/000697, with an international filing date of Mar. 22, 2004 (WO 2004/094153 A1, published Nov. 4, 2004), which is based on French Patent Application No. 03/04721, filed Apr. 15, 2003.

### FIELD OF THE INVENTION

This invention relates to methods and systems for printing base materials. In particular, but not exclusively, the invention in selected aspect relates to a multirack printing system.

### BACKGROUND

EP 973646 discloses an apparatus for printing base materials having a laser print unit for fast black and white printing and several inkjet print units for printing in color. The inkjet print units are disposed horizontally and in parallel and the apparatus comprises a horizontal distribution system, as well as a horizontal recovery system.

EP 767740 discloses a digital document printing system with multiple base materials comprising a plurality of digital print modules. In that system, each module comprises its own feed station for a continuous feeding of the printing means with printing materials. Each station also comprises means for cutting the base material after printing. A base material transporter means, of the endless belt type, is also provided for recovering the printed and cut base materials.

The systems of the prior art have the drawbacks of having a lengthy and tedious start-up (copying offset plates, ink ducts to be adjusted, passing papers for adjusting colors and the like). Moreover, the systems of the prior art use personnel highly skilled in various specializations. In addition, these systems work in a single format and need constant monitoring and adjustments, waste paper and cause significant chemical pollutions (inks, chemicals and the like). Finally, these systems are particularly expensive for a relatively low efficacy, both in terms of print quality and speed of execution.

### SUMMARY OF THE INVENTION

This invention relates to a method for printing a plurality of base materials with a device including a plurality of print units, a distribution system for distributing the base materials in the print units and a recovery system for recovering the printed base materials after each of the materials has passed through a print unit, including distributing the base materials in the print units through a top end portion of the print units with the distribution system; and recovering the printed base materials after each of the base materials has passed through a print unit through a bottom end portion of the print units with the recovery system.

This invention also relates to a printing system that implements the method, including a modular printing machine for printing base materials including at least one feed, at least one distribution system, at least one rack, at least one collecting belt and at least one receiving hopper.

### BRIEF DESCRIPTION OF THE DRAWINGS

The invention will be understood better with the help of the description, given below purely for explanation, of a selected embodiment of the invention, with reference to the accompanying figures:

FIG. 1 illustrates a partial view in section of a system for printing with chain distribution; and

FIG. 2 illustrates a partial view in section of a system for printing with belt distribution.

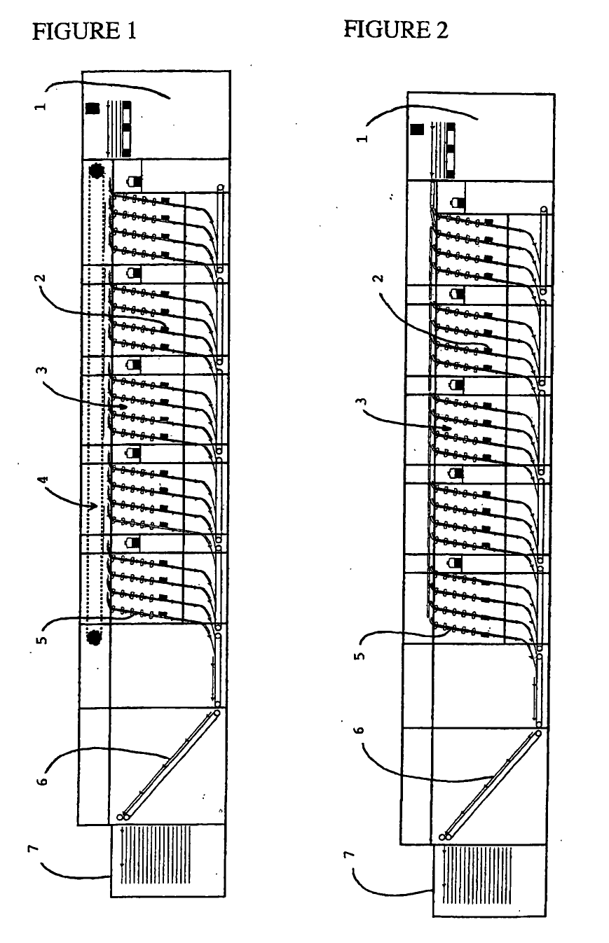

### DETAILED DESCRIPTION

It will be appreciated that the following description is intended to refer to specific embodiments of the invention selected for illustration in the drawings and is not intended to define or limit the invention, other than in the appended claims.

Selected aspects of this invention provide a compact industrial machine for carrying out inkjet printing on base materials brought to the printing by means of an automatic device and recovered after printing by means of an automatic device. The machine is thus able to combine many advantages of the offset printer and large-format inkjet plotters.

More precisely, in selected aspects of this invention, printing is carried out in a plurality of adjacent racks oriented substantially vertically and the base materials are fed, sheet by sheet, through the top of the machine. By virtue of a guidance system, the material falls by gravity vertically in a rack in which it can undergo printing on one side or both sides, along one axis or two. The base material is recovered after printing through the bottom of the rack.

To this end, one aspect of the invention concerns a printing method for printing a plurality of base materials by means of a device comprising a plurality of print units, as well as a distribution system for distributing the base materials in the print units and a recovery system for recovering the printed base materials after each of the materials has passed through a print unit, wherein the distribution system distributes the base materials in the print units through the top end of the print units and the recovery system recovers the printed base materials after each of the base materials has passed through a print unit through the bottom end of the print units.

Advantageously, the printing may be carried out in the modules on substantially vertical base materials.

The direction of the passage of the base materials through the machine is typically from right to left, but can also be from left to right.

Preferably, the supply of the various print materials can be effected either manually, for example, by means of a stacker or by virtue of a roller carriage, or automatically.

Selected aspects of the invention also relate to a printing system comprising a printing machine of the modular type of printing base materials, that is to say, comprising at least one feed, at least one distribution system, at least one rack, at least one collecting belt and at least one receiving hopper.

The printing system preferably comprises a plurality of print modules, for example, from two to five, each print module comprising at least four print racks. Each of the racks comprises an inkjet printer engine.

Advantageously, the printing machine comprises a printing rack situated between the feed and the receiving hopper and/or the distribution system and the collecting belt. Moreover, the rack can comprise a shutter, possibly automatic, able to open to receive a base material coming from the distribution system.

A printing rack serves to print the base materials, the latter sliding until the base material is gripped by rollers that drive the base material as far as the printer engine, and are then located (aligned), that is to say, each base material has a right or left reference depending on whether the printing of the base material is recto or verso. In each rack, there is a printer engine of the large-format inkjet type that does the printing.

Once the printing is finished, the rollers take up the base material again and eject it onto the connecting belt.

The rear of the above mentioned machine can comprise at least one access to compressors of the machine, at least one access to the electric cabinets and the automatic controller and/or at least one access to the collecting belt.

The rear part of the above mentioned machine may also comprise at least one access to ink reservoirs present in the machine so as to be able to recharge or replace them.

In the same way, the front part of the machine may comprise at least one access to the distribution device of the machine, at least one access to a data processing cabinet, at least one access to the racks equipping the machine and/or at least one access to the ink reservoirs.

The base materials may be made from paper, such as for example coated materials, laid materials, offset materials or special materials, or comprise opaque plastics, such as polyester “Teslin” (registered trade mark) or polycarbonate, or any other materials compatible with printer engines.

The printing machine may comprise a plurality of bars, each bar comprising a plurality of grippers able to close or open to grip or release each base material. In addition, the printing machine may comprise at least one bracket intended to guide each base material towards the above mentioned grippers or the above mentioned feed table.

Advantageously, the printing machine may comprise an adjustable-rate blower device, that is to say, at least one blower situated upright at the front of the stack of base materials and one blower situated upright at the rear of the stack of base materials; the front and rear blowers being adjustable independently.

The printing machine may comprise a suction nozzle situated at a support head, perpendicular to the direction of passage of the base materials.

The printing machine may also comprise at least one top feed table able to move in rotation to guide and release each base material. The printing machine may also comprise a suction box, coupled to the above mentioned suction nozzle, controlling sending of the base materials to the above mentioned grippers or the above mentioned feed table.

The gripper bars may be distant from one another by a distance of between about 50 centimeters and about 150 centimeters, preferably approximately 90 centimeters.

The distribution system may comprise at least one chain whose tension is provided by a tensioner disposed on each side of the printing machine. The rack may comprise a printer engine mounted on a rail provided with a removable fastener that makes the inkjet engine removable.

The collector belt preferably transports each base material discharged from the rack to the receiving hopper with register adjustment of the material.

The system can comprise a color checking device, for example, an artificial vision camera, cooperating with the above mentioned rack to correct if necessary the polychromatism of the materials printed by the rack. Thus, the polychromatism will be corrected by comparing a reference pattern with a pattern present on each printed base material.

By virtue of these particularities, the invention proposes a particular routing of the materials to be printed in the printing system, and more precisely for each material to be introduced through the top of the modules to be recovered at the bottom. The advantage of the system is thus two-fold: profiting from gravity to manage the introduction of each material into a module and its extraction and to carry out printing while the material is substantially vertical, to save space.

Loading the base material can take place in at least three ways, not shown in the figures:
1. manually, that is to say directly in the feed 1, for small formats;
2. by means of a stacker directly accessible on the feed platform 1, the base material having been prepared or realigned on an independent preparation station;
3. on one of the roller carriages, for example, of size 55×70 cm, and will not be able to accept a material with a maximum size of 50×65 cm.

A loading ramp is provided. This ramp, of low inclination, makes it possible to mount full stackers or carriages without difficulty.

The maximum capacity is about 5,000 items of base material of about 350 g, that is to say:
a maximum of about 1225 kg of base material, the weight of the plate and stacker being to be added;
a maximum base material height of about 1100 mm.

The stacker is used for large formats (weight). The system is used with compatible carriages for the feed 1 and receiving hopper 7. They are equipped with four orientable and lockable rollers. A manipulation handle must be provided on the large and small sides.

On these handles, a simple device is provided, hookable, snappable or the like, enabling the carriage to be maneuvered in the standing position, of the articulated rod type for example.

The feed 1 has several main functions:
Alignment of the support head along the squaring grid and before the gripping. This operation takes place when the feed 1 is loaded with the base materials;
Feeding the base materials into the machine, item by item.

In the direction perpendicular to the movement, the base materials are centered with respect to the machine axis (tolerance for positioning by the operator about ±10 mm). For this purpose, marks for the various formats and centring will have to be provided on the feed platform 1 and carriages.

The feed 1 is equipped with a real-time automatic leveller to keep the top of the base materials at the same height. The precision of positioning is approximately 2 mm. The rapid rise and descent of the feed platform 1 can be accessible to the operator in “manual movements” mode.

The horizontality of the plate is checked to within approximately 1 mm.

The manual movements of the plate may be as follows:
rapid descent of the plate to a low threshold at the approximate speed of 50 mm/s, and then in approach phase at a lower speed to make it possible to limit shocks and waiting at this position,
rapid raising of the platform until the top of the pallet arrives level with the suction box and nozzle at an approximate speed of 100 mm/s, and then in approach phase at a lower speed and maintenance of the top of the pallet at this level.

The manual movements of the plate may be accessible at the end of printing and during an interruption in printing.

The brackets serve to guide the support towards the gripper. The lateral brackets are adjustable manually to be adjusted, possibly automatically, to the various formats. They are retractable or raisable for the end of stack. The lateral brackets have a height of approximately 15 cm. They are situated at the top level of the stack and at the rear. The altitude or height of the brackets is constant, that is to say about 5 cm above the stack and about 10 cm below the top level of the stack. The lateral brackets are made from stainless metal.

An adjustable-rate blowing device is provided at the rear and front of the support stack at the high level; the adjustment being able to be different between the front and rear. This independent device also helps to unstick the base materials from one another. The device prepares the passage of the base materials.

The suction box controls sending the base materials to the grippers. It is coupled to the suction nozzle situated at the support head. The suction box can be adjusted for all formats:
front/rear: 29.7 to 72 cm
right/left: a breadth of 10 to 20 cm.

The suction box is fixed during its work. A platform situated under the box makes a reciprocating movement, that is to say, approximately 8 and about 10 cm.

This platform has three suction devices disposed in a triangle (two at the front, one at the rear). The two suction devices (suction cups) are situated at the front and mounted on an adjustable separation system.

At the rear of the box, a blower shoe descends on the second support when the suction devices raise the first. This shoe has three actions:
it helps to unstick the base materials from one another on the top of the stack,
it blows air between the first base material and the second base material in the tunnel created,
it keeps the second base material on the stack.

An air flow adjustment element is also provided in the system. The suction devices should have sufficient suction to unstick and hold a base material the format of 72×102 cm, having a weight of approximately 350 g/m².

The suction nozzle is situated at the top of the base material, slightly at the rear, that is to say, approximately at 8-10 cm. It is perpendicular to the direction of passage of the base material. Its function comprises lifting the first base material on the top of the stack, and bringing it as far as the gripper, via a roller acceleration system. It has ten suction devices distributed over a base material and according to the different base material formats. According to the formats used, certain suction devices, those at the ends, are situated in the “void.” The suction devices can close and open to adapt to the format of the base material.

Naturally, the reciprocating movement of the suction nozzle is synchronous with the suction box and gripper.

In the example chosen to illustrate the invention, the grippers are ten in number on each bar with intervals taking into account the various formats. Other numbers may be used as desired.

Each gripper has a gripping capability of a minimum of approximately 350 g. The gripper bars open and close according to the gripping or releasing of the material. The gripper bars are perpendicular to the chains. The set of gripper bars is fixed to the train chains disposed on the top part and on each side of the machine. Each rack 5 calls on a base material, the grippers open by default above a rack 5 situated at the end of the machine, this receptacle thus recovers the base materials which have not been able to be distributed. The base materials do not return to the feed 1.

The grippers are mounted in sets of two bars:
one bar where the grippers are fixed,
one bar triggering opening and closing of the grippers. This bar has at its end a cam that opens and closes the grippers simultaneously. The grippers are closed by default.

Each gripper has a return spring. In the event of breakage of this spring, the gripper will remain free so as not to interfere with the functioning of the machine. The grippers are able to open manually when the printing is stopped or interrupted.

In the example, each gripper bar is distant from the previous one by approximately 90 centimeters.

The chain train has a constant tension. A tensioner provides the tension in the chain. This tensioner is provided for each chain on each side of the machine. This device is situated at the end and on the reception hopper side 7, and thus the natural elongation of the chain is compensated for.

Guides are disposed on the tension length of the chain to prevent vibration and counter the reactions due to the openings of the gripper. The advance and speed of the chain are synchronous with the suction nozzle and suction box.

The distribution system 4 is ideally fully faired. This fairing is removable to allow extraction of jammed materials. Opening the fairing causes the distribution system 4 to stop. The speed of the system should at a minimum be about 0.7 m/s to facilitate the provisioning twenty racks 5.

The distribution 4 and synchronous systems are slowed down during printing, that is to say, setting to a slow speed when the distribution 4 does need to distribute base materials. They will stopped at the end of each series.

Front and rear manual movements will be available to be able to disengage a base material during an interruption in printing.

The printing rack 5 is the part situated between the feed 1 and the reception hopper 7 or between the distribution 4 and the connecting belt 6.

The printing rack 5 has several functions:
it receives the base material ready to be printed;
aligns or straightens the top sheet of base material;
aligns, or straightens, the base material on one side, left or right;
prints the base material;
ejects the printed base material.

The rack 5 is closed at the top by a flap that opens to receive a base material coming from the distribution system 4. The opening and closing of the aforesaid should be very rapid, and in addition there should be apertures to allow the grippers to pass. The opening system should be automated. The inherent speed and the inertia of the base material enable it to descend in the rack 5. The base material should be taken over in as far as the bottom of the rack 5.

Each item of base material is ejected onto the collecting belt 6 after printing. An adjustable pressure on rollers holds each base material during certain phases.

The print engine 2 is mounted on a rail for rapid changing or repair. (Re)positioning of this engine within the rack 5 has a precision of about 0.1 mm in amplitude to match the straightening system for the feed tables 1.

An attachment system for the engine is designed to allow another totally different engine, or one in replacement for a defective engine, but of similar size, to fit easily.

A collecting belt 6 transports the base materials leaving the rack 5 towards the reception hopper 7 with alignments of the material.

The speed of the belt 6 is comparable to that of the distribution 4. The belt 6 is started up as soon as a base material leaves a rack 5 and stopped as soon as there is no longer base material to be transported.

The reception hopper 7 functions in a similar manner to the feed 1. It receives the printed base materials from the racks 5 by means of the collecting belt 6.

The reception hopper 7 should be equipped with an automatic real-time leveller to keep the top of the materials always at the same height as the materials are stacked. The positional precision is approximately 2 mm.

A lateral and longitudinal alignment system straightens the supports as they arrive so as to position them centred with respect to the axis of the machine.

Addition of a blower at the end of the reception hopper 7 can be envisaged to simplify realignment. Alignment of the head of the base material pushes the base material towards the squaring grids. The rapid rise and descent of the reception platform 7 should be accessible to the operator in “manual movement” mode. Unloading the reception hopper 7 takes place in the same way and by the same means as loading the feed 1.

At the end of the reception hopper 7, the system is equipped with a color checking device using an artificial vision camera correcting the chroma of the materials printed by the printing rack 5. Thus, the base material is identified by a rack number 5 printed and reads a multicolor pattern making a comparison with a reference pattern, the calorimetric correction being made by means of the color card of the print engine 2 of the rack 5 analyzed.

The machine is supplied with ink by means of barrels with a capacity of approximately 35 litres per color. The barrels are integrated in the printing machine and can easily be exchanged by a single operator.

The level of the barrels should be monitored by a low-level threshold triggering an alert message, for example, able to be displayed on a display screen and/or of the audible type.

An identification device on each barrel should be able to prevent any confusion in the connection of the barrels.

The ink distributed in the small reservoirs is situated in the print racks 5, which redistributes in the heads of the print engines 2. The latter part is integrated and supplied with the print engines 2. The supply from the barrels to the small reservoirs can be designed so as to be entirely automatic.

The invention is described above by way of example. Naturally, a person skilled in the art is in a position to implement various embodiments of the invention without departing from the scope or spirit of the subject matter in the appended claims.

1. A method for printing a plurality of base materials with a device comprising a plurality of print units, a distribution system for distributing the base materials in the print units and a recovery system for recovering the printed base materials after each of the materials has passed through a print unit, comprising:
distributing the base materials in the print units through a top end portion of the print units with the distribution system; and
recovering the printed base materials after each of the base materials has passed through a print unit through a bottom end portion of the print units with the recovery system.

2. The method according to claim 1, wherein the printing is carried out in the modules on substantially vertical base materials.

3. The method according to claim 1, wherein the supply to the various print units takes place either manually or automatically.

4. A printing system that implements the method according to claim 1, comprising a modular printing machine for printing base materials comprising at least one feed, at least one distribution system, at least one rack, at least one collecting belt and at least one receiving hopper.

5. The printing system according to claim 4, further comprising a plurality of print modules, each module comprising at least four printing racks.

6. The printing system according to claim 4, wherein each rack comprises an inkjet printer engine.

7. The printing system according to claim 4, wherein a rear portion of the machine comprises at least one access to ink reservoirs present in the machine to be able to recharge or replace them.

8. The printing system according to claim 4, wherein the base materials are made from paper or plastics or materials compatible with printer engines.

9. The printing system according to claim 4, wherein the printing machine comprises a plurality of bars each having a plurality of grippers able to close or open to grip or release each item of base material.

10. The printing system according to claim 4, wherein the printer engine comprises at least one top feed table able to move in rotation to guide release of each item of base material.

11. The printing system according to claim 9, wherein the printing machine comprises at least one bracket that guides each item of base material towards the grippers.

12. The printing system according to claim 4, wherein the printing machine comprises an adjustable-rate blowing device comprising at least one blower situated vertically in front of a stack of base materials and a blower situated vertically at a rear portion of the stack of base materials; the front and rear blowers being independently adjustable.

13. The printing system according to claim 4, wherein the printing machine comprises a suction ramp situated at the top of a support, perpendicular to the direction of passage of the base materials.

14. The printing system according to claim 9, wherein the printing machine further comprises a suction box coupled to the suction nozzle controlling sending of the base materials to the grippers or the feed tables.

15. The printing system according to claim 4, wherein the printing machine comprises a rack situated between the feed and the receiving hopper and/or the distribution system and the collecting belt.

16. The printing system according to claim 15, wherein the printing rack comprises a flap, optionally automatic, able to open and receive a base material coming from the distribution system.

17. The printing system according to claim 6, wherein the rack comprises a motor mounted on a rail provided with a removable fastener.

18. The printing system according to claim 15, wherein the collecting belt transports each base material discharged from the rack to the receiving hopper with registering of the base material.

19. The printing system according to claim 4, comprising a color monitoring device cooperating with the rack to correct polychromy of the materials printed by the rack.
